(19) United States
(12) Patent Application Publication
(10) Pub. No.: US 2015/0095079 A1
(43) Pub. Date: Apr. 2, 2015

(54) DETERMINING ONE OR MORE SKILLS REQUIRED TO ADDRESS THE PROBLEM SYMPTOMS OF A PROBLEM REPORT FILES

(71) Applicant: International Business Machines Corporation, Armonk, NY (US)

(72) Inventors: Adam D. Braham, Rochester, MN (US); Dennis D. Koski, Oronoco, MN (US); Doyle J. McCoy, Rochester, MN (US); Jeffrey A. Schmidt, Rochester, MN (US)

(73) Assignee: International Business Machines Corporation, Armonk, NY (US)

(21) Appl. No.: 14/039,190

(22) Filed: Sep. 27, 2013

(51) Int. Cl. G06Q 10/06

(52) U.S. Cl. CPC G06Q 10/063112
USPC 705/7.14

(57) ABSTRACT

An approach for evaluating at least one problem report based on keyword parameters of the at least one problem report is provided. According to at least one aspect, the approach comprises determining problem symptoms of at least one problem report based on keywords of the problem symptoms. The approach further comprises comparing the keywords of the problem symptoms with skills of a symptom skills table in a computer data structure so as to rank a match of available skills to address the at least one problem report, wherein a rank is determined by closeness of match between the skills of the symptom skills table and the keywords of the problem symptoms to address the at least one problem report. The approach further comprises generating work assignments based on the ranked match of available skills.

### FIELD OF THE INVENTION

The present invention relates generally to data processing of computing systems, and more particularly to evaluating problem reports of computing systems based on keyword parameters of the problem reports.

### BACKGROUND

Technical problems reported to technical support teams may have multiple aspects requiring diverse skills to interpret data during an analysis phase of the technical problems. Certain technical problems typically take multiple problem segments to solve. Further, resolution time (or TTR for time-to-resolution) helps organizations or technical support teams track an average amount of time spent resolving the technical problems. For example, the greatest interest in TTR tends to be in the domain of technical support, where organizations and their customers share the common goal of resolving customer issues as quickly as possible. Further, for customers, this means returning to “operational status” as quickly as possible; for employers this means controlling support costs while maintaining customer satisfaction.

TTR can also be measured in hours or days depending on the nature of the product or system being supported, and is measured from the time a support request is logged until the time problem identified in the request is closed. Many factors can contribute to TTR. These factors include the communication skills and technical expertise of both the representative and the customer, the representative's access to relevant resources, and his or her troubleshooting skills. In addition, the representative's caseload and his or her diligence in corresponding with the customer can also be factor that contributes to TTR.

### SUMMARY

An approach for evaluating at least one problem report based on keyword parameters of the at least one problem report. In one embodiment, a method is provided for evaluating at least one problem report based on keyword parameters of the at least one problem report. The method comprises determining, by one or more processors, problem symptoms of the at least one problem report based on keywords of the problem symptoms. The method further comprises comparing, by the one or more processors, the keywords of the problem symptoms with skills of a symptom skills table in a computer data structure so as to rank a match of available skills to address the at least one problem report, wherein a rank is determined by closeness of match between the skills of the symptom skills table and the keywords of the problem symptoms to address the at least one problem report. The method further comprises generating by the one or more processors, work assignments based on the ranked match of available skills.

In another embodiment, a computer system is provided for evaluating at least one problem report based on keyword parameters of the at least one problem report. The computer system comprises one or more processors, one or more computer-readable memories, one or more computer-readable tangible storage devices and program instructions which are stored on at least one of the one or more storage devices for execution by at least one of the one or more processors via at least one of the one or more memories. The computer system further comprises program instructions to determine problem symptoms of at least one problem report based on keywords of the problem symptoms. The computer system further comprises program instructions to compare the keywords of the problem symptoms with skills of a symptom skills table in a computer data structure so as to rank a match of available skills to address the at least one problem report, wherein a rank is determined by closeness of match between the skills of the symptom skills table and the keywords of the problem symptoms to address the at least one problem report. The computer system further comprises program instructions to generate work assignments based on the ranked match of available skills.

In yet another embodiment, a computer program product for archiving business processes in a virtualized cloud computing environment is provided. The computer program product comprises one or more processors, one or more computer-readable memories, one or more computer-readable tangible storage devices and program instructions which are stored on at least one of the one or more storage devices for execution by at least one of the one or more processors via at least one of the one or more memories. The computer program product further comprises program instructions to determine problem symptoms of at least one problem report based on keywords of the problem symptoms. The computer program product further comprises program instructions to compare the keywords of the problem symptoms with skills of a symptom skills table in a computer data structure so as to rank a match of available skills to address the at least one problem report, wherein a rank is determined by closeness of match between the skills of the symptom skills table and the keywords of the problem symptoms to address the at least one problem report. The computer program product further comprises program instructions to generate work assignments based on the ranked match of available skills.

### BRIEF DESCRIPTION OF THE SEVERAL VIEWS OF THE DRAWINGS

Novel characteristics of the invention are set forth in the appended claims. The invention will best understood by reference to the following detailed description of the invention when read in conjunction with the accompanying figures, wherein like reference numerals indicate like components, and:

FIG. 1 is a functional system diagram of a problem symptom management environment for determining a problem symptom of at least one problem report, in accordance with an embodiment of the present invention, is shown.

FIG. 2 depicts a block diagram of components of a computer system, in accordance with embodiments of the present invention.

FIG. 3 depicts a flow diagram of a computer-implemented method for evaluating at least one problem report based on keyword parameters of the at least one problem report in accordance with embodiments of the present invention.

### DETAILED DESCRIPTION

The present invention comprises an approach for evaluating problem reports based on keyword parameters of the problem reports. According to at least one embodiment of the present invention, a determination of problem symptoms of the problem reports is performed based on keywords of the problem symptoms.

Further, the determined problem symptoms of the problem reports are stored in a repository of a computer based system, wherein the stored problem symptom includes skill types and various levels of the problem symptom, time to resolution of the problem symptom, and amount of hours required to resolve the problem symptoms. According to at least one embodiment, the determined problem symptom keywords are matched with a symptom skill table of the repository, wherein a match is performed to identify the closed skill set for the problem report. For example, comparison is performed of the keywords of the problem symptoms with skills of a symptom skills table in a computer data structure so as to rank a match of available skills to address the problem reports, wherein a rank is determined by closeness of match between the skills of the symptom skills table and the keywords of the problem symptoms to address the problem reports.

In particular, for example, aspects of the present invention query the determined problem symptoms of the problem reports to search for a skill set or combination of skill sets for solving the problem report, wherein the skill set or combination of skill sets attempt to reduce required time of resolution of the problem report.

A ranking system is also provided to query the a list of available skills to work on the problem report, build a set of potential work assignments for the problem report, and priorities from the query set, and dispatches the work assignments according to the matched rankings. Another embodiment of the present invention further includes a speech to text conversion of the problem reports, wherein the speech or short message service is analyzed to rank the match of available skills to address the problem reports, in accordance with embodiments of the present invention.

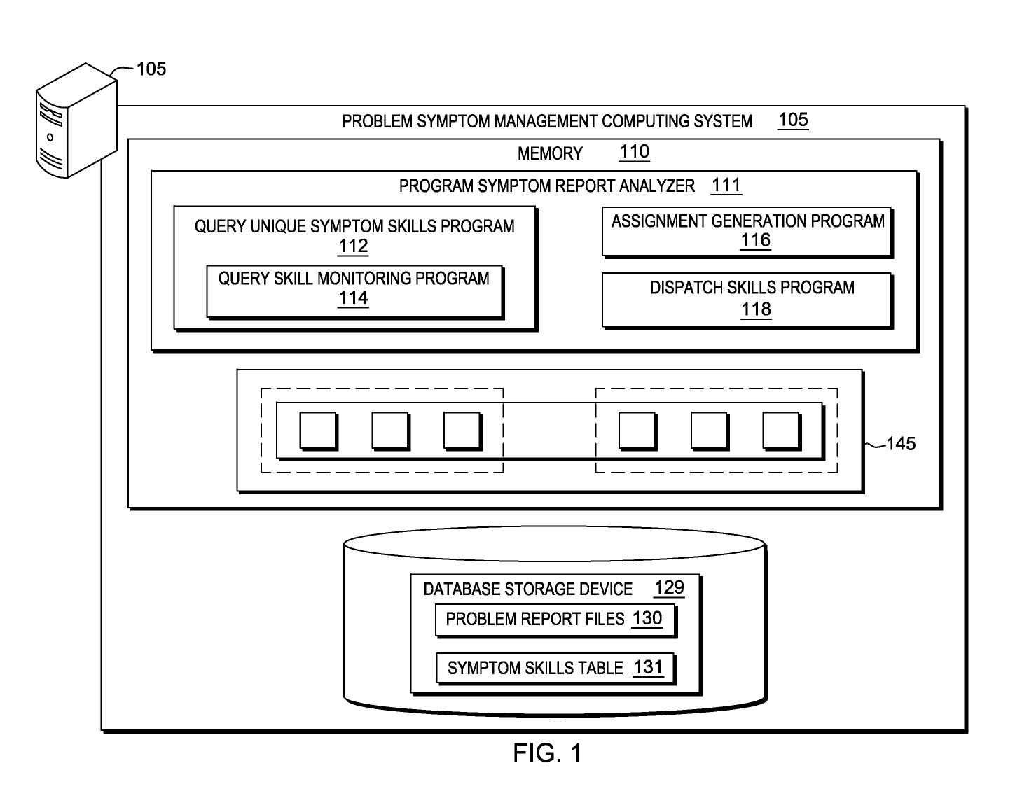

The present invention will now be described in detail with reference to the accompanying Figures. Referring now to FIG. 1, a functional system diagram of problem symptom management environment 100 for determining a problem symptom of at least one problem report, and combination of skills required to address the problem report based on symptom skills parameters of the combined skills in problem symptom management computing system 105, in accordance with an embodiment of the present invention, is shown.

According to at least one aspect, problem symptom management computing system 105 can be for example, a laptop, tablet, or notebook personal computer (PC), a desktop computer, a mainframe or mini computer, a personal digital assistant (PDA), or a smart phone such as a Blackberry® (Blackberry is a registered trademark of Research in Motion Limited (RIM) Inc., in the United States, other countries, or both) or iPhone® (iPhone is a registered trademark of Apple Inc., in the United States, other countries, or both), respectively. Problem symptom management computing system 105 can also be a server computing system such as a management server, a web server, or any other electronic device or computing system.

The server computing system can also represent a “cloud” of computers interconnected by one or more networks, wherein the server computing system can be a primary server for a computing system utilizing clustered computers when accessed through a virtual computing environment of computing device 100. For example, a cloud computing system can be a common implementation of a management system that determines a problem symptom of a problem report, and combination of skills required to address the problem report according to parameters of the combined skills of computing device 100.

Problem symptom management computing system 105 includes database storage device 129 and memory 110. Database storage device 129 can be any type of storage device, storage server, storage area network, redundant array of independent discs (RAID), cloud storage device, or any type of data storage that maintains information that relates to resource skills of workgroups, or teams, including for example, historical performance evaluations, or success rates of previous problems or historical records of workflows performed by the workgroups. Database storage device can also be for example, DB2®. For example, DB2® can be relational model database server. The relational model for database management of database storage device is a database model based on first-order predicate logic. In the relational model of a database, all data is represented in terms of tuples, grouped into relations. For example, a relation of the relational model is defined as a set of tuples that have the same attributes.

Database storage device 129 includes problem report files 130 and symptom skills table 131. Problem report files 130 can be problem reports of systems failures of computing systems, or debugging files of computing system during a system failure or operating system crash of a computing system, wherein problem report files 130 can be a segment or input recorded or stored from various sources of one or more computing system, including for example, a web based reporting system of the one or more computing systems, a chat based reporting system of the one or more computing system, or any other electronic medium. Problem report files 130 are transmitted to a problem management system of computing device, wherein problem report files 130 is analyzed to determine problem symptoms of problem reports based on keywords of the problem symptoms of problem report files 130, as described below.

Symptom skills table 131 includes a record of available skills of resources, including, human resources that are available to address a problem being solved or dealt with in problem report files 130. For example, according to at least one embodiment of the present invention, a determination of problem symptoms of the problem report files 130 is performed based on keywords of the problem symptoms of problem report files 130. Further, the determined problem symptoms of problem report files 130 are stored database storage device 129, wherein the stored problem symptom includes skill types and various levels of the problem symptom, time to resolution of the problem symptom, and amount of hours required to resolve the problem symptoms of problem report files 130.

The determined problem symptom keywords are matched with symptom skills table 131, wherein a match is performed to identify the closest skill set of symptom skills table 131 to address problem report files 129. For example, in an embodiment, a comparison is performed of the keywords of the problem symptoms with skills of symptom skills table 131 so as to rank a match of available skills to address the problem report files 130, wherein a rank is determined by closeness of match between the skills of the symptom skills table 131 and the keywords of the problem symptoms to address problem reports files 130.

Symptom skills table 131 further includes historical symptoms, resources and skill levels required to address problem report files 130. According to at least one aspect, symptom skills table can be a relational table that includes for example, a table of record of problems addressed and resolution times of the addressed problems of at least one or more problem report files 130. Symptom skills table 131 can also include an existing knowledge of skills to address problem report files 130 and their symptoms to address problem report files 130.

Memory 110 may comprise, for example, one or more computer-readable storage media, which may include random-access memory (RAM) such as various forms of dynamic RAM (DRAM), e.g., DDR2 SDRAM, or static RAM (SRAM), flash memory, or any other form of fixed or removable storage medium that can be used to carry or store desired program code and program data in the form of instructions or data structures and that can be accessed by other components of computing device 100. Memory 110 includes address space 145. In the depicted environment of problem symptom management environment 100. Address space 145 is composed of addressable memory locations for one or more program applications that execute program instructions of memory 110.

Address space 145 also defines a range of discrete addresses of memory 110, each of which may correspond to a network host, peripheral device, disk sector, a memory cell or other logical or physical entity of memory 110. In the depicted embodiment, memory stores problem symptom report analyzer 111. According to at least one embodiment, problem symptom report analyzer 111 obtains transmission of at least one problem report as input from problem report files 130, and determines problem symptoms from the problem reports by determining symptom keywords in problem report files 130.

Problem symptom report analyzer 111 further matches the symptom keywords with input skills of symptom skills table 131 for the closest match of problem report files 130, wherein an exact match ranks the highest an exact match of the keywords and input skills of the symptom skills table 131 ranks the highest of available skills to address the problem report files 130. Problem symptom report analyzer 111 further utilizes a ranking query of the ranked match to query a list of available skills for problem report files 130, and generates a set of potential work assignments and priorities from the ranked query to dispatch work assignments according to the ranked query list, in accordance with at least one embodiment of the present invention.

According to at least one embodiment, problem symptom report analyzer 111 queries an entire management record of problem report files 130 to determine problem symptoms of problem report files 130 based on keywords of the problem symptoms that can be identified in a symptom skills table 131 of problem symptom management computing system 105, wherein input skills of the symptom skills table 131 are compared with the keywords of the problem symptoms to rank a match of available skills to address the problem report files 130, as described below, in accordance with embodiments of the present invention.

In an exemplary embodiment for example, fuzzy search methods can be utilized by problem symptom report analyzer 111 to translate or query symptom table for problem synonyms of problem report files 130 based on keywords of the problem symptoms, as well as various tenses and forms of the symptom words of the problem symptom that can be used to further refine and exemplify the input problem description of problem symptoms against the input skills of symptom table in database storage device 129. Further, a search of input skills of symptom skills table 131 by problem symptom report analyzer 111 provides a list of skill, and base skill levels for solving the problem.

For example, query of symptom skills table 131 by problem symptom report analyzer 111 provides an established skill list as the set of all skills of the query. The skill level of each skill would be established as the maximum skill of any one particular symptom requiring that skill. Another exemplary embodiment of the present invention may include the direction of speech or short message service (SMS) text conversion from problem report files 130 into problem symptom report analyzer 111, wherein the speech or SMS of the text conversion is analyzed to identify symptom strings to determine problem symptoms of problem reports files 130. For example, the analyzed symptom strings of the speech or short message service (SMS) text conversion could then be used as an input to a skills query for the inclusion of additional skills and levels based on the symptom string.

According to at least one embodiment, problem symptom report analyzer 111 could be executed across multiple problem segments of problem report files to identify additional or accurate skills match to address the problem being solved. For example, problem symptom report analyzer 111 could be executed across the multiple segments of problem report files 130 to identify additional problem symptoms of problem reports files 130 based on keywords of the problem symptoms to resolve the problem, including for example, identification of existing skills of the problem symptoms of problem reports files 130, including skill levels of the existing skills, with newly queried skills from a recent problem symptom keyword determination of problem report files. Moreover, additional skills of problem symptoms of problem report files 130 can be monitored and recommended for addressing the current problem being solved, as those additional skills are available. Monitoring of the additional skills could be based on periodically, randomly, and/or using event-based monitoring of the additional skills that are available to address the problem being addressed or solved.

Query unique symptom skills program 112 takes the input symptom skills of symptom skills table 131, as a string to perform a search of the symptom skills table 131. For example, such a query obtains all rows from symptom skills table 131 containing any of the keywords problem symptoms of problem report files 130 based on keywords of the problem symptoms analyzed by problem symptom report analyzer 111, as described above, in accordance with at least one embodiment of the present invention. Moreover, a ranking by query unique symptom skills program 112 is assigned to each row of the searched symptom skills table 131 that contains any of the keywords problem symptoms of problem report files 130 based on keywords of the problem symptoms analyzed by problem symptom report analyzer 111.

For example, a row containing substantially the same terms of the keywords of the problem symptom analyzer 111 would rank high, for example, 100 would be a percentage of terms matched being 100% and percentage of additional terms in the returned row is 0. For example, a ranking formula of query unique symptom skills table can include:

$$Ranking = \frac{\# input terms matched}{\# input terms} - \frac{\# returned row terms not matched}{\# returned row terms}$$

For example, other ranking formulas could use various combinations of percentages to attempt to improve rankings. Query unique symptom skills program 112 includes query symptom skill monitoring program 114. Query skill monitoring program 114 produces a query ranked list of potential skills base on the performed search of the symptom skills table 131 against the keywords problem symptoms of problem reports files 130 based on keywords of the problem symptoms analyzed by problem symptom report analyzer 111.

For example, assignment generation program 116 creates work assignment for dispatching work for the problem being addressed or solved. The query of assignment generation program 116 could produce a ranked list of skills available based on skill level and cost of skill where the attempt to minimize the cost of the skills usage on the problem is implemented and balanced against the need for the skill's immediate availability, then ranking increased cost of the skill next, followed by reduced skill last. Other embodiments may use different ranking orders that will bring varying results in minimizing cost of problems, maximizing customer satisfaction. In the depicted embodiment, assignment generation program 116 takes the results from the query of available skills and produces a prioritized work assignment list containing a list of possible skills to match each skills need identified by query unique symptom skills program 112. Dispatch skills program 118 monitors available resources that match the skills produced by assignment generation program 116 to identify the highest priority skill first, then subsequently dispatch each subsequent skill as required and available, in accordance with an embodiment of the present invention.

In an embodiment, key to a global workforce, language of the caller, and possibly of the skills required to solve the problem could be present. Other global workforce constraints may also be present that produce a higher priority skill requirement. In such assignments, creation of work assignments by assignment generation program 116 are transmitted to dispatch skills program 118 that is responsible from assigning the work in priority to the next available symptom skills that is found from the skills availability of query unique symptom skills program 112. Another embodiment could make use of the amount of time a caller will wait on the phone before hanging up, and ensuring resources are dispatched before that point in time. A third embodiment could include both the survey aspect, as well as the average time a client disconnects as a criterion for depleting client satisfaction.

Another embodiment of the present invention may include the use of the skills of problem symptoms of problem report files 130 to query knowledge content of input skills of symptom skills table 131 to recommend high ranking knowledge content based on the problem symptoms of problem report files 130. Thereafter, by tagging that knowledge content of input skills of symptom skills table 131 with the skills and skill levels required for implementation or addressing problem symptoms of problem report files 130, dispatcher skills program 118 rely on the skill tags of problem symptoms of problem report files 130, and associate content knowledge content of input skills of symptom skills table 131 with the problem symptoms of problem report files 130.

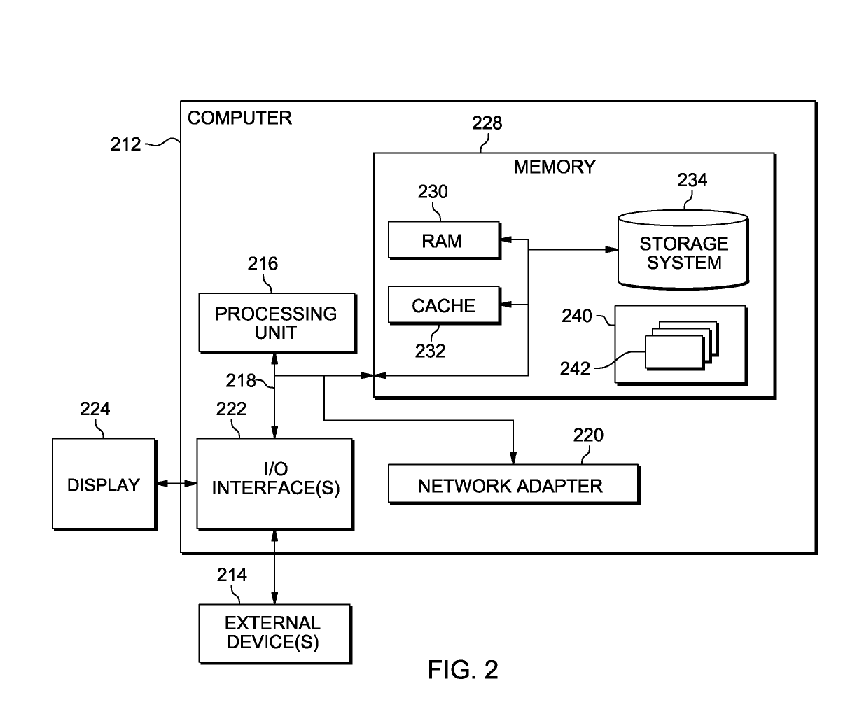

FIG. 2 is a functional system diagram of a computer system, in accordance with an embodiment of the present invention.

Computer system 200 is only one example of a suitable computer system and is not intended to suggest any limitation as to the scope of use or functionality of embodiments of the invention described herein. Regardless, computer system 200 is capable of being implemented and/or performing any of the functionality set forth hereinabove. In computer system 200 there is computer 212, which is operational with numerous other general purpose or special purpose computing system environments or configurations. Examples of well-known computing systems, environments, and/or configurations that may be suitable for use with computer 212 include, but are not limited to personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Problem symptom management computing system 105 can be implemented as an instance of computer 212.

Computer 212 may be described in the general context of computer system executable instructions, such as program modules, being executed by a computer system. Generally, program modules may include routines, programs, objects, components, logic, data structures, and so on that perform particular tasks or implement particular abstract data types. Computer 212 may be practiced in distributed cloud computing environments where tasks are performed by remote processing devices that are linked through a communications network. In a distributed cloud computing environment, program modules may be located in both local and remote computer system storage media including memory storage devices.

As further shown in FIG. 2, computer 212 is shown in the form of a general-purpose computing device. The components of computer 212 may include, but are not limited to, one or more processors or processing units 216, memory 228, and bus 218 that couples various system components including memory 228 to processing unit 216.

Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 212 typically includes a variety of computer system readable media. Such media may be any available media that is accessible by computer 212, and includes both volatile and non-volatile media, and removable and non-removable media.

Memory 228 includes computer system readable media in the form of volatile memory, such as random access memory (RAM) 230 and/or cache 232. Computer 212 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of the invention.

Problem symptom analyzer 111 can be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 242 generally carry out the functions and/or methodologies of embodiments of the invention as described herein. Problem symptom analyzer 111 can be implemented as an instance of program 240.

Computer 212 may also communicate with one or more external devices 214 such as a keyboard, a pointing device, etc., as well as display 224; one or more devices that enable a user to interact with computer 212; and/or any devices (e.g., network card, modem, etc.) that enable computer 212 to communicate with one or more other computing devices. Such communication occurs via Input/Output (I/O) interfaces 222. Still yet, computer 212 communicates with one or more networks such as a local area network (LAN), a general wide area network (WAN), and/or a public network (e.g., the Internet) via network adapter 220. As depicted, network adapter 220 communicates with the other components of computer 212 via bus 218. It should be understood that although not shown, other hardware and/or software components could be used in conjunction with computer 212. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustrations are implemented by special purpose hardware-based systems that perform the specified functions or acts, or combinations of special purpose hardware and computer instructions.

As will be appreciated by one skilled in the art, embodiments of the present invention may be embodied as a system, method or computer program product. Accordingly, embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the present invention may take the form of a computer program product embodied in one or more computer-readable medium(s) having computer-readable program code embodied thereon.

In addition, any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that contains, or stores a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that communicates, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing. Computer program code for carrying out operations for embodiments of the present invention may be written in any combination of one or more programming languages, including an object oriented programming language such as Java, Smalltalk, C++ or the like, conventional procedural programming languages such as the “C” programming language, a hardware description language such as Verilog, or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

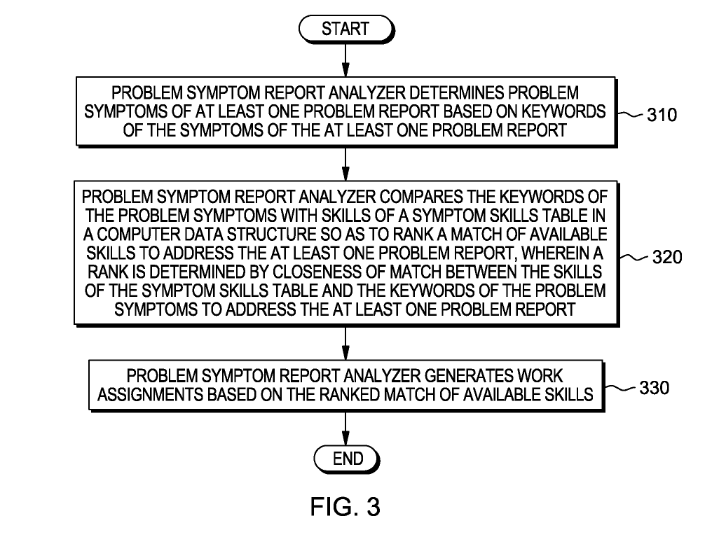

FIG. 3 is a flow diagram of a computer-implemented method for evaluating at least one problem report based on keyword parameters of the at least one problem report in accordance with embodiments of the present invention. Problem symptom analyzer 111 determines problem symptoms of at least one problem report of problem report files 130 based on keywords of the problem symptoms of problem report files 130. (Step 310).

For example, problem report files can be, for example, a speech or short message service, and wherein the speech or short message service is analyzed to rank the match of available skills to address the at least one problem report of problem report files 130. Moreover, problem report files 130 can also be problem reports of systems failures of computing systems, or debugging files of computing system during a system failure or operating system crash of a computing system, wherein problem report files 130 can be a segment or input recorded or stored from various sources of one or more computing system, including, for example, a web based reporting system of the one or more computing systems, a chat based reporting system of the one or more computing system, or any other electronic medium. According to at least one embodiment of the present invention, the determined problem symptoms of problem report files 130 are stored in database storage device 129, wherein the stored problem symptom includes skill types and various levels of the problem symptom, time to resolution of the problem symptom, and amount of hours required to resolve the problem symptoms.

The determined problem symptom keywords are matched with symptom skill table 131 of database storage device 129, wherein a match is performed to identify the closed skill set for the problem report files 130, and wherein a determined closeness of match of the available skills between the skills of the symptom skills table 131 and the keywords of the problem symptoms to address the at least one problem report of problem report files 130 ranks the highest of available skills to address a problem being solved. For example, according to at least one embodiment, problem symptom analyzer 111 further compares keywords of the problem symptoms with skills of a symptom skills table in a computer data structure so as to rank a match of available skills to address the problem reports, wherein a rank is determined by closeness of match between the skills of the symptom skills table and the keywords of the problem symptoms to address the problem reports. (Step 320). According to at least one embodiment, problem symptom analyzer 111 generates work assignments based on the ranked match of available skills (Step 330). For example, problem symptom analyzer 111 identifies entries in symptom skills table 131 that contains keywords of the problem symptoms of problem report files 130, and ranks assignment of each entry based on the ranked match of available skills, in accordance with embodiments of the present invention. Problem symptom analyzer 111 further creates a ranked list of potential skills that can be utilized to rank a match of the available skills.

Based on the foregoing a method for evaluating problem reports based keyword parameters of the problem reports within a computer system have been described. However, numerous modifications and substitutions can be made without deviating from the scope of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. Therefore, the present invention has been disclosed by way of example and not limitation.

What is claimed is:

1. A computer-implemented method for evaluating at least one problem report, the method comprising:
determining, by one or more processors, problem symptoms of at least one problem report based on keywords of the problem symptoms;
comparing, by the one or more processors, the keywords of the problem symptoms with skills of a symptom skills table in a computer data structure so as to rank a match of available skills to address the at least one problem report, wherein a rank is determined by closeness of match between the skills of the symptom skills table and the keywords of the problem symptoms to address the at least one problem report; and
generating, by the one or more processors, one or more work assignments based on the ranked match of available skills.

2. The method according to claim 1, further comprising steps of:
identifying, by the one or more processors, entries in the symptom skills table that contains keywords of the problem symptoms; and
ranking, by the one or more processors, assignment of each entry based on the ranked match of available skills.

3. The method according to claim 2, wherein an entry containing substantially the same keywords as the keywords of the problem symptoms is ranked highly as compared to an entry that does not contain the same keywords.

4. The method according to claim 2, further comprising: creating, by the one or more processors, a ranked list of potential skills that can be utilized to rank a match of the available skills.

5. The method according to claim 1, wherein the at least one problem report is a speech or short message service, and wherein the speech or short message service is analyzed to rank the match of available skills to address the at least one problem report.

6. The method according to claim 1, wherein a relative closeness of match of the available skills between the skills of the symptom skills table and the keywords of the problem symptoms to address the at least one problem report determines the rank of the available skills.

7. The method according to claim 1, wherein the symptom skills table comprises a list of the available skills in a computer based repository to address the at least one problem report.

8. A computer system for evaluating at least one problem report, the computer system comprising:
one or more processors, one or more computer-readable memories, one or more computer-readable tangible storage devices and program instructions which are stored on at least one of the one or more storage devices for execution by at least one of the one or more processors via at least one of the one or more memories, the program instructions comprising:
program instructions to determine problem symptoms of at least one problem report based on keywords of the problem symptoms;
program instructions to compare the keywords of the problem symptoms with skills of a symptom skills table in a computer data structure so as to rank a match of available skills to address the at least one problem report, wherein a rank is determined by closeness of match between the skills of the symptom skills table and the keywords of the problem symptoms to address the at least one problem report; and
program instructions to generate work assignments based on the ranked match of available skills.

9. The computer system according to claim 8, further comprises:
program instructions to identify entries in the symptom skills table that contains keywords of the problem symptoms; and
program instructions to rank assignment of each entry based on the ranked match of available skills.

10. The computer system according to claim 9, wherein an entry containing substantially the same keywords as the keywords of the problem symptoms is ranked highly as compared to an entry that does not contain the same keywords.

11. The computer system according to claim 9, further comprises: program instructions to create a ranked list of potential skills that can be utilized to rank a match of the available skills.

12. The computer system according to claim 8, wherein the at least one problem report is a speech or short message service, and wherein the speech or short message service is analyzed to rank the match of available skills to address the at least one problem report.

13. The computer system of claim 8, wherein a relative closeness of match of the available skills between the skills of the symptom skills table and the keywords of the problem symptoms to address the at least one problem report determines the rank of the available skills.

14. A computer program product for evaluating at least one problem report based on keyword parameters of the at least one problem report, the computer program product comprising:
one or more computer-readable tangible storage devices and program instructions stored on at least one of the one or more storage devices, the program instructions comprising:
program instructions to determine problem symptoms of at least one problem report based on keywords of the problem symptoms;
program instructions to compare the keywords of the problem symptoms with skills of a symptom skills table in a computer data structure so as to rank a match of available skills to address the at least one problem report, wherein a rank is determined by closeness of match between the skills of the symptom skills table and the keywords of the problem symptoms to address the at least one problem report; and
program instructions to generate work assignments based on the ranked match of available skills.

15. The computer program product according to claim 14, further includes:
program instructions to identify entries in the symptom skills table that contains keywords of the problem symptoms; and
program instructions to rank assignment of each entry based on the ranked match of available skills.

16. The computer program product according to claim 15, wherein an entry containing substantially the same keywords as the keywords of the problem symptoms is ranked highly as compared to an entry that does not contain the same keywords.

17. The computer program product according to claim 14, further comprises: program instructions to create a ranked list of potential skills that can be utilized to rank a match of the available skills.

18. The computer program product according to claim 14, wherein the at least one problem report is a speech or short message service, and wherein the speech or short message service is analyzed to rank the match of available skills to address the at least one problem report.

19. The computer program product of claim 14, wherein a relative closeness of match of the available skills between the skills of the symptom skills table and the keywords of the problem symptoms to address the at least one problem report determines the rank of the available skills.

20. The computer program product of claim 14, wherein the symptom skills table includes a list of the available skills in a computer based repository to address the at least one problem report.
